(19) United States
(12) Patent Application Publication
(10) Pub. No.: US 2004/0232395 A1
(43) Pub. Date: Nov. 25, 2004

(54) HOIST

(75) Inventor: Mr. Les BROOKS, Liverpool (GB)

Correspondence Address: BROWN, RAYSMAN, MILLSTEIN, FELDER & STEINER LLP, 900 THIRD AVENUE, NEW YORK, NY, 10022, US

(73) Assignee: Huntleigh Technology PLC, Bedfordshire (GB)

(21) Appl. No.: 10/779,174

(22) Filed: Feb. 13, 2004

(30) Foreign Application Priority Data
Feb. 24, 2003 (GB) 0304176.1

(51) Int. Cl. B60P 1/48

(52) U.S. Cl. 254/8 R; 212/901

(57) ABSTRACT

### Abstract of the Disclosure

A hoist pivotally connecting mast 1 to lifting arm 2, by a mechanism comprising a link 5 pivoting about a fixed pivot 8 on the mast 1 and a moving pivot 6 on the lifting arm 2. A restraining link 9 between a pivot 10 on the mast 1 and actuator attachment point 11 on the lifting arm 2 restricts the movement of link 5. The second link 9 acts as a stabilizer allowing the pivot 11 on the lifting arm 2 to move only through a set arc, determined by the length of the link 9 and the position of the pivot 10 on the mast 1. With the moving pivot according to the invention, the spreader bar attachment point 7 has a greater traveling distance than if it were simply pivoted about pivot 8 as with conventional hoists.

### Detailed Description of the Invention

### Cross Reference to Related Applications

This application claims priority to United Kingdom patent application No. 0304176.1, filed February 24, 2003.

### Background of Invention

The invention relates to a hoist.

It is known to have hoists comprising a mobile chassis, a mast upstanding from the chassis pivotably supporting a lifting arm at its upper end, the lifting arm having a sling attachment at its opposite end. An actuator between the mast and the lifting arm moves the lifting arm about its pivot point with the mast through a given arc. Figure 1 shows such a prior art hoist with an actuator 12 connected to a mast 1 of the hoist and driving a lifting arm 2 by means of pivot 4, the lifting arm 2 rotated about an arc around pivot 3 on the upper part of the mast 1 of the hoist. However, with such known hoists the lifting arm moves through a limited range of movement between the high and low positions and further requires a large actuator for its operation.

### Summary of Invention

The present invention seeks to make improvements. Accordingly, the present invention provides a hoist comprising a chassis, a mast upstanding from the chassis, the mast pivotally supporting a lifting arm at one end wherein the position of the pivot varies with movement of the lifting arm. Among other advantages, the provision of a moving pivot between the mast and the lifting arm results in a larger lifting range for a given lifting arm driven by an actuator of given length. The moving pivot may comprise a link pivotally connected to the mast about a fixed point and pivotally connected to the lifting arm about a moving pivot point. A stabilizing link attached to the mast and actuator may restricts the movement of the moving pivot link.

By the provision of a moving pivot, the invention increases the travel of the lift normally achieved by the same actuator in a fixed pivot hoist.

Thus a smaller, discreet and economic actuator can achieve a greater lifting range and reach.

### Brief Description of Drawings

An embodiment of the present invention is described below, by way of example only, with reference to the accompanying drawings in which:

Figure 1 is a schematic view of a hoist with the prior art fixed pivot system;

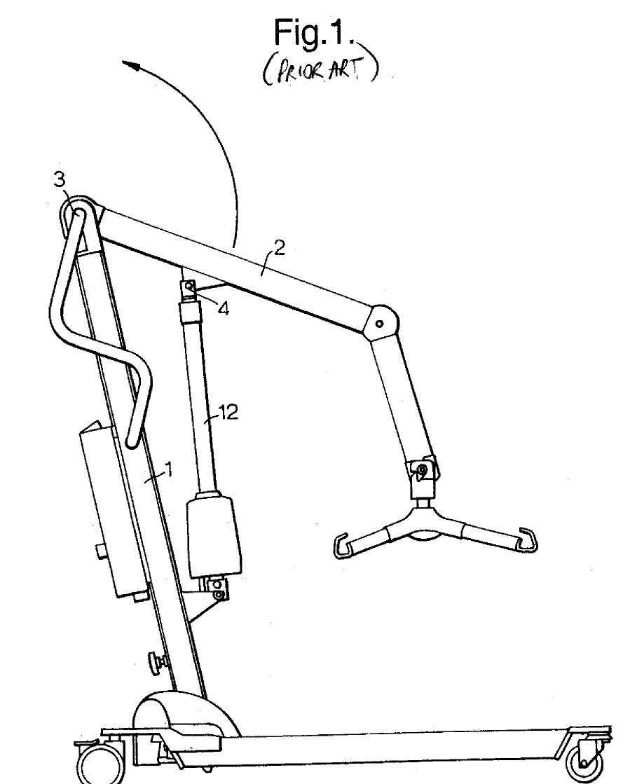

Figure 2 is a schematic view of a hoist according to the invention in the lowered position; and

Figure 3 is a schematic view of a hoist according to the invention in the raised position.

### Detailed Description

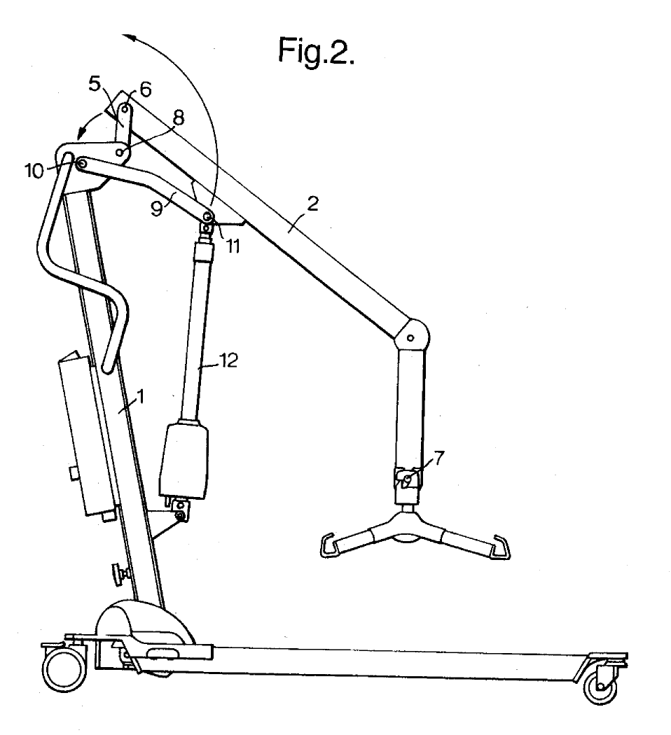

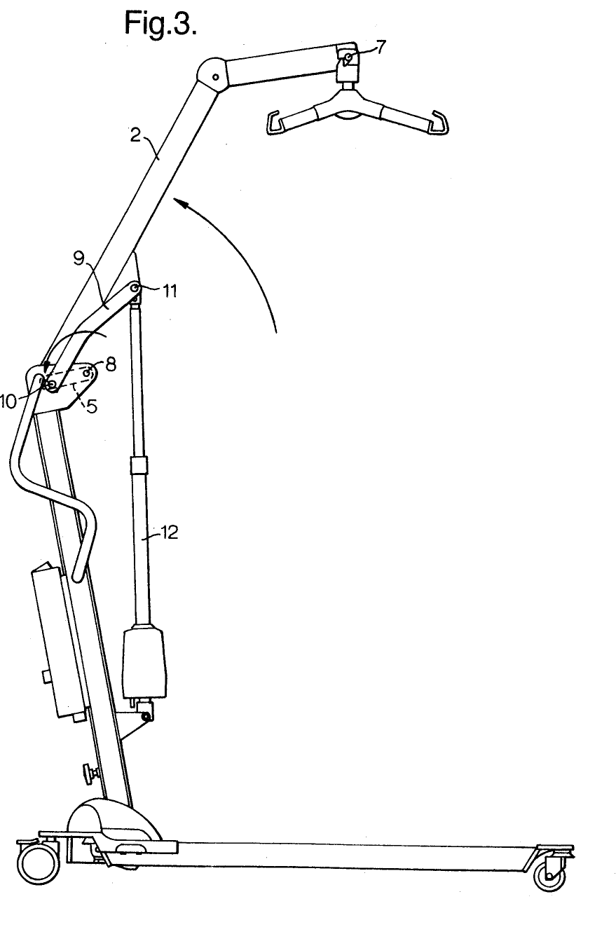

In the embodiment shown in Figures 2 and 3, the invention consists of a hoist having a mechanism pivotally connecting mast 1 to lifting arm 2. The mechanism comprises a link 5 pivoting about a fixed pivot 8 on the mast 1 and about a moving pivot 6 on the lifting arm 2. One or more restraining links 9 between a pivot 10 on the mast 1 and actuator attachment point 11 on the lifting arm 2 restricts the movement of link 5 and a stabilizer allowing the pivot 11 on the lifting arm 2 to move only through a set arc, determined by the length of the link 9 and the position of the pivot 10 on the mast 1. As shown in Figure 2, when the lifting arm 2 is at its lowest position link 5 is at it its furthest point clockwise restricted by the compression of acuator 12. As the actuator 12 pushes up the lifting arm 2, link 5 rotates anticlockwise about pivot 8. As shown in Figure 3, as the lift progresses, link 5 continues to move through its arc until the limit of the actuator stroke is reached. Therefore with the moving pivot according to the invention, the spreader bar attachment point 7 has a greater traveling distance than if it were simply pivoted about pivot 8 as with conventional hoists.

In the embodiment shown, the moving pivot moves arcuately from the position of pivot 6 shown in Figure 2 to a position of pivot 10 as shown in Figures 2 and 3, providing a greater range of height and lift using the same actuator.

What is Claimed is:

1. A hoist comprising a chassis, a mast upstanding from the chassis, the mast pivotally supporting a lifting arm at a position one end wherein the position of the pivot varies with movement of the lifting arm.

2. A hoist as claimed in claim 1 wherein the moving pivot comprises a link pivotally connected to the mast about a fixed point and pivotally connected to the lifting arm about a moving pivot point.

3. A hoist as claimed in claim 2 wherein a stabilizing link attached to the mast and actuator restricts the movement of the moving pivot link.

4. A hoist comprising: a mast; a lifting arm; a link pivotally connecting the mast and the lifting arm; an actuator for moving the lifting arm relative to the mast; and a stabilizing link attached to the mast and at least one of the actuator and the lifting arm, to restrict movement of the link pivotally connecting the mast and the lifting arm.
